(19) United States
(12) Patent Application Publication
(10) Pub. No.: US 2024/0023555 A1
(43) Pub. Date: Jan. 25, 2024

(54) PESTICIDAL COMPOSITIONS

(71) Applicant: SYNGENTA CROP PROTECTION AG, Basel (CH)

(72) Inventors: Francesca FALLUTO, Bracknell, Berkshire (GB); Gemma HALLAM-BARNES, Bracknell, Berkshire (GB)

(73) Assignee: SYNGENTA CROP PROTECTION AG, Basel (CH)

(21) Appl. No.: 18/254,668

(22) PCT Filed: Nov. 26, 2021
(86) PCT No.: PCT/EP2021/083127

§ 371 Date: May 26, 2023

(30) Foreign Application Priority Data
Nov. 27, 2020 (EP) 20210432.9

(51) Int. Cl. A01N 47/40; A01P 7/04

(52) U.S. Cl. CPC A01N 47/40; A01P 7/04

(57) ABSTRACT

A pesticidal composition comprising: (i) 25 to 35% by weight of spiropidion; (ii) 20 to 30% by weight of acetamiprid; and (iii) 2.5 to 10% by weight of a buffering agent, which based on the total weight of the composition is (a) 2 to 7% by weight of an alkali metal sulfate or an alkaline earth metal sulfate, and (b) 0.1 to 5% by weight of an organic acid.

The present invention relates to a composition comprising a combination of insecticidal active ingredients, to the preparation of such compositions, and to a method of using such a composition to control pests in crops of useful plants.

Insecticidal compositions containing combinations of the insecticidal active ingredient spiropidion with another active ingredient are known, eg, from WO 2013/107793. However, in certain compositions for use in insect control on crop plants, the chemical instability of the active ingredient (eg, spiropidion) may be an issue which results in a loss of insecticidal performance. Accordingly, there remains a strong motivation to develop insecticidal compositions where for practical purposes the active ingredient component retains long-term chemical stability.

According to the present invention, there is provided a pesticidal composition comprising:
(i) 25 to 35% by weight of spiropidion;
(ii) 20 to 30% by weight of acetamiprid; and
(iii) 2.5 to 10% by weight of a buffering agent, which based on the total weight of the composition, comprises:

(a) 2 to 7% by weight of an alkali metal sulfate and/or an alkaline earth metal sulfate, and
(b) 0.1 to 5% by weight of an organic acid.

The pesticidal compositions of the invention have, for practical purposes, a very advantageous level of activity in controlling insect pests in crops of useful plants after foliar or soil application, whilst also maintaining acceptable crop safety (phytotoxicity) outcomes. By activity, it is meant that the compositions of the invention are capable of killing or controlling insects, retarding the growth or reproduction of insects, reducing an insect population, and/or reducing damage to plants caused by insects.

Furthermore, surprisingly it has been found for the present invention that the addition of an organic acid (eg, citric acid) to certain compositions comprising spiropidion and acetamiprid, significantly improves the chemical stability of the spiropidion active ingredient component and thus the useful storage life of compositions containing these two active ingredients.

Further according to the invention, there is provided an aqueous composition comprising the pesticidal composition according the invention, optionally further comprising one or more adjuvants or carriers.

Still further according to the invention, there is provided a (non-therapeutic) method of combating and controlling pests which comprises applying to a pest, to a locus of a pest, or to a crop of a useful plant susceptible to attack by a pest a composition according to the invention.

Spiropidion ([3-(4-chloro-2,6-dimethyl-phenyl)-8-methoxy-1-methyl-2-oxo-1,8-diazaspiro[4.5]dec-3-en-4-yl]ethyl carbonate. CAS no.: 1229023-00-0) is known inter alia from WO 2010/066780, WO 2018/114648 and WO 2018/114649. Acetamiprid ((1E)-N-[(6-chloro-3-pyridyl)methyl]-1V-cyano-N-methyl-acetamidine. CAS no.: 135410-20-7) is known inter alia from EP 0 456 826. Certain pesticidal mixtures comprising spiropidion and acetamiprid as active ingredients are known from WO 2013/107793.

Preferably, the compositions according to the invention comprise as the pesticidal active ingredient component (i) 28 to 32% by weight of spiropidion and (ii) 22 to 26% by weight of acetamiprid, and more preferably (i) 29 to 31% by weight of spiropidion and (ii) 23 to 25% by weight of acetamiprid.

The compositions according to the invention comprise as the pesticidal active ingredient component spiropidion and acetamiprid, respectively, in a weight ratio of 5:6 to 7:4, and preferably a weight ratio of 1:1 to 3:2.

Preferably, the compositions according to the invention comprise 4.5 to 8% by weight of a buffering agent, of which based on the total composition comprises 4 to 6% by weight of an alkali metal sulfate, and 0.5 to 2.5% by weight of an organic acid. Most preferably, the compositions according to the invention comprise 4.5 to 6.5% by weight of a buffering agent, of which based on the total composition comprises 4 to 6% by weight of an alkali metal sulfate, and 0.5 to 1.5% by weight of an organic acid.

More preferably, the compositions according to the invention comprise 4.5 to 8% by weight of a buffering agent, of which based on the total composition comprises 4 to 6% by weight of an alkali metal sulfate, and 0.5 to 2.5% by weight of citric acid. Most preferably, the compositions according to the invention comprise 4.5 to 6.5% by weight of a buffering agent, of which based on the total composition comprises 4 to 6% by weight of an alkali metal sulfate, and 0.5 to 1.5% by weight of citric acid.

In the buffering agent component of the compositions of the invention, there may be included an alkali metal sulfate or an alkaline earth metal sulfate, or else a combination of an alkali metal sulfate and an alkaline earth metal sulfate. Preferably, the alkali metal sulfate used in the compositions of the invention is potassium sulfate or sodium sulfate, and most preferably sodium sulfate.

Preferably, the organic acid used in accordance with the present invention is an organic acid that contains 1, 2 or 3 carboxylic acid groups. More preferably, the organic acid is a tricarboxylic acid (ie, contains three carboxylic acid groups). Even more preferably, the organic acid is citric acid, or a salt thereof, such as the sodium or potassium salt of citric acid (sodium citrate or potassium citrate). Most preferably, the organic acid is citric acid.

In preferred embodiments, the compositions of the invention further comprise based on the total weight of the composition (ie, up to 100% by weight):
(iv) 15 to 20% by weight of one or more dispersants;
(v) 1 to 5% by weight of an anti-foaming agent; and
(vi) 15 to 30% by weight of a filler, wherein optionally the filler based on the total weight of the composition comprises:
   (c) 5 to 15% by weight of a polymethyl urea resin filler, and
   (d) 10 to 15% by weight of a lactose monohydrate filler.

In other preferred embodiments, the compositions of the invention may comprise 1 to 3% by weight of an anti-foaming agent, and preferably 1.5 to 2.5% by weight of an anti-foaming agent.

In other preferred embodiments, the compositions of the invention may comprise 15 to 25% by weight of a filler, and preferably 18 to 22% by weight of a filler.

Preferably, the composition of the invention is a water-dispersible granule (WG), which may be defined as a solid, granular formulation which can disperse or dissolve quickly when added to water in a spray tank, thus providing a fine particle suspension comprising a pesticidal active ingredient or ingredients. A water-dispersible granule comprising the composition according to the present invention may be prepared according to standard methods. The water-dispersible granule may take the form of an extruded granule or a spray-agglomerated granule.

Preferably, in an aqueous composition according to the invention (eg, a tank mix preparation for applying to a crop), the adjuvant is selected from a mineral oil, a vegetable oil, an esterified vegetable oil, a methylated vegetable oil or an alkyl ester phosphate-based adjuvant. A pesticide adjuvant may be defined as a substance present in a pesticidal composition (eg, a concentrated active ingredient formulation diluted in water in a tank for a foliar spray application on a crop), which improves pesticidal active ingredient performance, for example by facilitating the spreading of the active ingredient on a leaf surface or penetration into the leaf of the crop plant.

Examples of adjuvant classes, which may be used in accordance with the present invention include a mineral oil, a vegetable oil, an esterified vegetable oil, a methylated vegetable oil or an alkyl ester phosphate-based adjuvant. Commercially-available adjuvant products which may be tank-mixed to yield a spray formulation with the composition of the present invention include HASTEN™ (Victorian Chemical Co. Pty. Ltd.-blend of an esterified vegetable oil and non-ionic surfactants), OCHIMA® (Syngenta—alkyl ester of phosphoric acid (EC formulation)), LEDNA™ (Polaquimia—EC formulation comprising a methyl ester of soybean oil), Atplus® 463 (CRODA Europe Limited—60% parafin oil with surfactant blend), Actirob® B (Bayer AG—rapeseed oil methyl ester (esterified vegetable oil)), Destiny® HC (Winfield Solutions LLC—methylated soybean oil), DYNE-AMIC® (HELENA—blend of (methylated) vegetable oil and organosilicone-based nonionic surfactants), and FS Optique™ (GROVVMARK, Inc—methyl ester of canola oil).

If an alkyl ester phosphate-based adjuvant is used in conjunction with the pesticidal composition according to the invention (ie, in a tank mix), the alkyl ester phosphate of the adjuvant is preferably tris-(2-ethylhexyl) phosphate, preferably in combination with ethoxylated sorbitol, hexaoleate, eg, OCHIMA®—EC, Syngenta.

A dispersant or a dispersing agent is typically a surfactant substance, which when added to a suspension of solid particles in a liquid better enables the separation of the particles to avoid their settling or clumping together. Dispersants which may be used in accordance with the present invention include, but are not limited to, lignosulphonate salts (eg, Ufoxane 3A, Borregard AS; Borresperse NA, Borregard AS; Polyfon™ H, Ingevity; Marasperse CBOS-4 powder, LignoTech), naphthalene sulfonic acid salts (eg, Dispergator B Gran, TFL Ledertechnik GmbH), a co-polymer of 2,5-furandione and 2,4,4-trimethylpentene (eg, Geropon® Ta/72, Solvay).

An anti-foaming agent is a chemical additive that reduces and hinders the formation of foam in a composition, such as a pesticidal formulation. Anti-foaming agents which may be used in accordance with the present invention include, but are not limited to, polydimethylsiloxanes (eg, XIAMETER™ ACP-1500, Dow, Inc; Antifoam MSA, Univar; Xiameter ACP-0001, Dow Brasil; Xiameter ACP-0100, Dow Chemical).

Fillers which may be used in accordance with the present invention include, but are not limited to, a polymethyl urea resin (Pergopak® M, Huber Engineered Materials; Cropal UF100H, Yoo Sung Chem R&T Co. Ltd), lactose monohydrate (Pharmatose® 200M, DFE Pharma; lactose monohydrate, Foremost Farms USA; Excipress™, Armor Pharma; Excipure™, Armor Pharma; lactose anhydrous, Kerry Inc).

Examples of pests which may be controlled in accordance with the compositions of the present invention include those:
from the order Acarina, for example, Acalitus spp, Aculus spp, Acaricalus spp, spp, Acarus siro, Amblyomma spp., Argas spp., Boophilus spp., Brevipalpus spp., Bryobia spp, Calipitrimerus spp., Chorioptes spp., Dermanyssus gaffinae, Dermatophagoides spp, Eotetranychus spp, Eriophyes spp., Hemitarsonemus spp, Hyalomma spp., Ixodes spp., Olygonychus spp, Ornithodoros spp., Polyphagotarsone latus, Panonychus spp., Phyllocoptruta oleivora, Phytonemus spp, Polypha-gotarsonemus spp, Psoroptes spp., Rhipicephalus spp., Rhizoglyphus spp., Sarcoptes spp., Steneotarsonemus spp, Tarsonemus spp. and Tetranychus spp.;
from the order Anoplura, for example, Haematopinus spp., Linognathus spp., Pediculus spp., Pemphigus spp. and Phylloxera spp.;
from the order Coleoptera, for example, Agriotes spp., Amphimallon majale, Anomala orientalis, Anthonomus spp., Aphodius spp, Astylus atromaculatus, Ataenius spp, Atomaria linearis, Chaetocnema tibialis, Cerotoma spp, Conoderus spp, Cosmopolites spp., Cotinis nitida, Curculio spp., Cyclocephala spp, Dermestes spp., Diabrotica spp., Diloboderus abderus, Epilachna spp., Eremnus spp., Heteronychus arator, Hypothenemus hampei, Lagria vilosa, Leptinotarsa decemLineata, Lissorhoptrus spp., Lyogenys spp, Maecolaspis spp, Maladera castanea, Megascelis spp, Melighetes aeneus, Melolontha spp., Myochrous armatus, Orycaephilus spp., Otiorhynchus spp., Phyllophaga spp, Phlyctinus spp., Popiffia spp., Psyffiodes spp., Rhyssomatus aubtilis, Rhizopertha spp., Scarabeidae, Sitophilus spp., Sitotroga spp., Somaticus spp, Sphenophorus spp, Sternechus subsignatus, Tenebrio spp., Tribolium spp. and Trogoderma spp.;
from the order Diptera, for example, Aedes spp., Anopheles spp, Antherigona soccata,Bactrocea oleae, Bibio hortulanus, Bradysia spp, Calliphora erythrocephala, Ceratitis spp., Chrysomyia spp., Culex spp., Cuterebra spp., Dacus spp., Delia spp, Drosophila melanogaster, Fannia spp., Gastrophilus spp., Geomyza tripunctata, Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis spp, Rivelia quadrifasciata, Scatella spp, Sciara spp., Stomoxys spp., Tabanus spp., Tannia spp. and Tipula spp.;
from the order Hemiptera, for example, Acanthocoris scabrator, Acrosternum spp, Adelphocoris lineolatus, Amblypelta nitida, Bathycoelia thalassina, Blissus spp, Cimex spp., Clavigralla tomentosicoffis, Creontiades spp, Distantiella theobroma, Dichelops furcatus, Dysdercus spp., Edessa spp, Euchistus spp., Eurydema pulchrum, Eurygaster spp., Halyomorpha halys, Horcias nobilellus, Lep-tocorisa spp., Lygus spp, Margarodes spp, Murgantia histrionic, Neomegalotomus spp, Nesidiocoris tenuis, Nezara spp., Nysius simulans, Oebalus insularis, Piesma spp., Piezodorus spp, Rhodnius spp., Sahlbergella singularis, Scaptocoris castanea, Scotinophara spp., Thyanta spp, Triatoma spp., and Vatiga illudens;
from the order Homoptera, for example, Acyrthosium pisum, Adalges spp, Agalliana ensigera, Agonoscena targionii, Aleurodicus spp, Aleurocanthus spp, Aleurolobus barodensis, Aleurothrixus floccosus, Aleyrodes brassicae, Amarasca biguttula, Amritodus atkinsoni, Aonidiella spp., Aonidiella auranti, Aphididae, Aphis spp., Aspidiotus spp., Aulacorthum solani, Bactericera cockereffi, Bemisia spp, Brachycaudus spp, Brevicoryne brassicae, Cacopsylla spp, Cavariella aegopodii Scop., Ceroplaster spp., Chrysomphalus aonidium, Chrysomphalus dictyospermi, Cicadella spp, Cofana spectra, Cryptomyzus spp, Cicadulina spp, Coccus hesperidum, Dalbulus maidis, Dialeurodes spp, Diaphorina citri, Diuraphis noxia, Dysaphis spp, Empoasca spp., Eriosoma larigerum, Erythroneura spp., Gascardia spp., Glycaspis brimblecombei, Hyadaphis pseudobrassicae, Hyalopterus spp, Hyperomyzus pallidus, Idioscopus clypealis, Jacobiasca lybica, Laodelphax spp., Lecanium corni, Lepidosaphes spp., Lopaphis erysimi, Lyogenys maidis, Macrosiphum spp., Mahanarva spp, Metcalfa pruinosa, Metopolophium dirhodum, Myndus crudus, Myzus spp., Neotoxoptera sp, Nephotettix spp., Nilaparvata spp., Nippolachnus piri Mats, Odonaspis ruthae, Oregma lanigera Zehnter, Parabemisia myricae, Paratrioza cockerelli, Parlatoria spp., Pemphigus spp., Peregrinus maidis, Perkinsiella spp, Phorodon humuli, Phylloxera spp, Planococcus spp., Pseudaulacaspis spp., Pseudococcus spp., Pseudatomoscelis seriatus, Psylla spp., Pulvinaria aethiopica, Quadraspidiotus spp., Quesada gigas, Recilia dorsalis, Rhopalosiphum spp., Saissetia spp., Scaphoideus spp., Schizaphis spp., Sitobion spp., Sogatella furcifera, Spissistilus festinus, Tarophagus Proserpina, Toxoptera spp, Trialeurodes spp, Tridiscus sporoboli, Trionymus spp, Trioza erytreae, Unaspis citri, Zygina flammigera, and Zyginidia scutellaris;
from the order Hymenoptera, for example, Acromyrmex, Arge spp, Atta spp., Cephus spp., Diprion spp., Diprionidae, Gilpinia polytoma, Hoplocampa spp., Lasius spp., Monomorium pharaonis, Neodiprion spp., Pogonomyrmex spp, Slenopsis invicta, Solenopsis spp. and Vespa spp.;
from the order Isoptera, for example, Coptotermes spp, Corniternes cumulans, Incisitermes spp, Macrotermes spp, Mastotermes spp, Microtermes spp, Reticulitermes spp.; Solenopsis geminate;
from the order Lepidoptera, for example, Acleris spp., Adoxophyes spp., Aegeria spp., Agrotis spp., Alabama argillaceae, Amylois spp., Anticarsia gemmatalis, Archips spp., Argyresthia spp, Argyrotaenia spp., Autographa spp., Bucculatrix thurberiella, Busseola fusca, Cadra cautella, Carposina nipponensis, Chilo spp., Choristoneura spp., Chrysoteuchia topiaria, Clysia ambiguella, Cnaphalocrocis spp., Cnephasia spp., Cochylis spp., Coleophora spp., Colias lesbia, Cosmophila flava, Crambus spp, Crocidolomia binotalis, Cryptophlebia leucotreta, Cydalima perspectalis, Cydia spp., Diaphania perspectalis, Diatraea spp., Diparopsis castanea, Earias spp., Eldana saccharina, Ephestia spp., Epinotia spp, Estigmene acrea, Etiella zinckinella, Eucosma spp., Eupoecilia ambiguella, Euproctis spp., Euxoa spp., Feltia jaculiferia, Grapholita spp., Hedya nubiferana, Heliothis spp., Hellula undalis, Herpetogramma spp, Hyphantria cunea, Keiferia lycopersicella, Lasmopalpus lignosellus, Leucoptera scitella, Lithocollethis spp., Lobesia botrana, Loxostege bifidalis, Lymantria spp., Lyonetia spp., Malacosoma spp., Mamestra brassicae, Manduca sexta, Mythimna spp, Noctua spp, Operophtera spp., Orniodes indica, Ostrinia nubilalis, Pammene spp., Pandemis spp., Panolis flammea, Papaipema nebris, Pectinophora gossypiela, Perileucoptera coffeella, Pseudaletia unipuncta, Phthorimaea operculella, Pieris rapae, Pieris spp., Plutella xylostella, Prays spp., Pseudoplusia spp, Rachiplusia nu, Richia albicosta, Scirpophaga spp., Sesamia spp., Sparganothis spp., Spodoptera spp., Sylepta derogate, Synanthedon spp., Thaumetopoea spp., Tortrix spp., Trichoplusia ni, Tuta absoluta, and Yponomeuta spp.;
from the order Mallophaga, for example, Damalinea spp. and Trichodectes spp.;
from the order Orthoptera, for example, Blatta spp., Blattella spp., Gryllotalpa spp., Leucophaea maderae, Locusta spp., Neocurtilla hexadactyla, Periplaneta spp. , Scapteriscus spp, and Schistocerca spp.;
from the order Psocoptera, for example, Liposcelis spp.;
from the order Siphonaptera, for example, Ceratophyllus spp., Ctenocephalides spp. and Xenopsylla cheopis;
from the order Thysanoptera, for example, Calliothrips phaseoli, Frankliniella spp., Heliothrips spp, Hercinothrips spp., Parthenothrips spp, Scirtothrips aurantii, Sericothrips variabilis, Taeniothrips spp., Thrips spp; and/or
from the order Thysanura, for example, Lepisma saccharina.

Examples of soil-inhabiting pests, which can damage a crop in the early stages of plant development, are:
from the order Lepidoptera, for example, Acleris spp., Aegeria spp., Agrotis spp., Alabama argillaceae, Amylois spp., Autographa spp., Busseola fusca, Cadra cautella, Chilo spp., Crocidolomia binotalis, Diatraea spp., Diparopsis castanea, Elasmopalpus spp., Heliothis spp., Mamestra brassicae, Phthorimaea operculella, Plutella xylostella, Scirpophaga spp., Sesamia spp., Spodoptera spp. and Tortrix spp.;
from the order Coleoptera, for example, Agriotes spp., Anthonomus spp., Atomaria linearis, Chaetocnema tibialis, Conotrachelus spp., Cosmopolites spp., Curculio spp., Dermestes spp.,
Diabrotica spp., Dilopoderus spp., Epilachna spp., Eremnus spp., Heteronychus spp., Lissorhoptrus spp., Melolontha spp., Orycaephilus spp., Otiorhynchus spp., Phlyctinus spp., Popillia spp., Psyffiodes spp., Rhizopertha spp., Scarabeidae, Sitotroga spp., Somaticus spp., Tanymecus spp., Tenebrio spp., Tribolium spp., Trogoderma spp. and Zabrus spp.;
from the order Orthoptera, for example, Gryllotalpa spp.;
from the order Isoptera, for example, Reticulitermes spp.;
from the order Psocoptera, for example, Liposcelis spp.;
from the order Anoplura, for example, Haematopinus spp., Linognathus spp., Pediculus spp., Pemphigus spp. and Phylloxera spp.;
from the order Homoptera, for example, Eriosoma larigerum;
from the order Hymenoptera, for example, Acromyrmex, Atta spp., Cephus spp., Lasius spp., Monomorium pharaonis, Neodiprion spp., Solenopsis spp. and Vespa spp.;
from the order Diptera, for example, Tipula spp.;
crucifer flea beetles (Phyllotreta spp.), root maggots (Delia spp.), cabbage seedpod weevil (Ceutorhynchus spp.) and aphids.

In particular, the compositions of the invention may be applied against insects from the order Homoptera (in particular, white flies, aphids, psyllids and armoured and soft scales), Thysanoptera (thrips), Acarina (mites) and Lepidoptera (butterflies and moths, and larva thereof). Preferably, the compositions of the invention may be applied against white flies, aphids, thrips.

Crops of useful plants in which the compositions according to the invention can be used include perennial and annual crops, such as berry plants for example blackberries, blueberries, cranberries, raspberries and strawberries; cereals for example barley, maize (corn), millet, oats, rice, rye, sorghum triticale and wheat; fibre plants for example cotton, flax, hemp, jute and sisal; field crops for example sugar and fodder beet, coffee, hops, mustard, oilseed rape (canola), poppy, sugar cane, sunflower, tea and tobacco; fruit trees for example apple, apricot, avocado, banana, cherry, citrus, nectarine, peach, pear and plum; grasses for example Bermuda grass, bluegrass, bentgrass, centipede grass, fescue, ryegrass, St. Augustine grass and Zoysia grass; herbs such as basil, borage, chives, coriander, lavender, lovage, mint, oregano, parsley, rosemary, sage and thyme; legumes for example beans, lentils, peas and soya beans; nuts for example almond, cashew, ground nut, hazelnut, peanut, pecan, pistachio and walnut; palms for example oil palm; ornamentals for example flowers, shrubs and trees; other trees, for example cacao, coconut, olive and rubber; vegetables for example asparagus, aubergine, broccoli, cabbage, carrot, cucumber, garlic, lettuce, marrow, melon, watermelon, okra, onion, leek, pepper, potato, pumpkin, squash, rhubarb, spinach and tomato; and vines for example grapes. The compositions of the invention can also be applied on turf, lawn and pastures.

Preferably, the compositions of the invention may be applied to a crop of a useful plant selected from:
the order Solanacea (including tomato, potato, aubergine, chilli, pepper, tobacco);
the order Cucurbitaceae (including squash, pumpkin, watermelon, melon, cucumber);
the order Alliaceae (including onion, garlic, leek);
the order Asparagacea (including asparagus).

Preferably, the composition of the invention may be applied to a crop of a useful plant selected from cucumber, squash, pepper, melon, watermelon, tomato, aubergine, courgette or gourd.

The rate at which the agrochemical compositions of the invention are applied will depend upon the particular type of insect, etc, to be controlled, the degree of control required and the timing and method of application and can be readily determined by the person skilled in the art. In general, the compositions of the invention can be applied at an application rate of between 0.005 kilograms/hectare (kg/ha) and about 5.0 kg/ha, based on the total amount of active ingredient in the composition. An application rate of between about 0.1 kg/ha and about 1.5 kg/ha is preferred, with an application rate of between about 0.3 g/ha and 0.8 kg/ha being especially preferred.

The pesticidal compositions of the present invention may be used as an insecticide to control pests on cotton plants or soybean plants, in particular for the control of insects from the order Homoptera (in particular, white flies, aphids, psyllids and armoured and soft scales), Thysanoptera (thrips) and Acarina (mites).

In particular, transgenic cotton events expressing useful traits which may be used in combination with the compositions of the invention, include BXN10211, BXN10215, BXN10222, BXN10224, COT102, COT67B, GHB614, GHB119, LLCotton25, MON531, MON757, MON15985, MON1445, MON88913, MON1076, MON1698, MON88701, T304-40, 281-24-236, 3006-210-23, 31707, 31803, 31808, 42317, and the like. Such combinations of the compositions of the invention with cotton events expressing one or more useful traits may provide more durable yield protection, provide a resistance management strategy for target pest control, and reduce farmer inputs, saving considerable expense in time and monetary value.

Furthermore, transgenic soybean plants expressing toxins, for example insecticidal proteins such as delta-endotoxins, e.g. Cry1Ac (Cry1Ac Bt protein) may be used in combination with the compositions of the invention. Accordingly, this may include transgenic soybean plants comprising event MON87701 (see U.S. Pat. No. 8,049,071 and related applications and patents, as well as WO 2014/170327 A1 (eg, see paragraph reference to Intacta RR2 PRO™ soybean)), event MON87751 (US. Patent Application Publication No. 2014/0373191) or event DAS-81419 (U.S. Pat. No. 8,632,978 and related applications and patents).

Other transgenic soybean plants may comprise event SYHT0H2—HPPD tolerance (U.S. Patent Application Publication No. 2014/0201860 and related applications and patents), event MON89788-glyphosate tolerance (U.S. Pat. No. 7,632,985 and related applications and patents), event MON87708 dicamba tolerance (U.S. Patent Application Publication No. US 2011/0067134 and related applications and patents), event DP-356043-5-glyphosate and ALS tolerance (U.S. Patent Application Publication No. US 2010/0184079 and related applications and patents), event A2704-12-glufosinate tolerance (U.S. Patent Application Publication No. US 2008/0320616 and related applications and patents), event DP-305423-1-ALS tolerance (U.S. Patent Application Publication No. US 2008/0312082 and related applications and patents), event A5547-127-glufosinate tolerance (U.S. Patent Application Publication No. US 2008/0196127 and related applications and patents), event DAS-40278-9-tolerance to 2,4-dichlorophenoxyacetic acid and aryloxyphenoxypropionate (see WO 2011/022469, WO 2011/022470, WO 2011/022471, and related applications and patents), event 127-ALS tolerance (WO 2010/080829 and related applications and patents), event GTS 40-3-2-glyphosate tolerance, event DAS-68416-4-2,4-dichlorophenoxyacetic acid and glufosinate tolerance, event FG72-glyphosate and isoxaflutole tolerance, event BPS-CV127-9-ALS tolerance and GU262-glufosinate tolerance or event SYHTO4R-HPPD tolerance.

In an aqueous composition comprising the pesticidal composition according to the invention (eg, a tank-mix composition) there may be added a further component comprising a pesticidal active ingredient selected from one or more of:

Abamectin, Acequinocyl, Acetoprole, Acrinathrin, Acynonapyr, Afidopyropen, Afoxalaner, Alanycarb, Allethrin, Alpha-Cypermethrin, Alphamethrin, Amidoflumet, Aminocarb, Azocyclotin, Bensultap, Benzoximate, Benzpyrimoxan, Betacyfluthrin, Beta-cypermethrin, Bifenazate, Bifenthrin, Binapacryl, Bioallethrin, Bioallethrin S)-cyclopentylisomer, Bioresmethrin, Bistrifluron, Broflanilide, Brofluthrinate, Bromophos-ethyl, Buprofezine, Butocarboxim, Cadusafos, Carbaryl, Carbosulfan, Cartap, CAS number: 1472050-04-6, CAS number: 1632218-00-8, CAS number: 1808115-49-2, CAS number: 2032403-97-5, CAS number: 2044701-44-0, CAS number: 2128706-05-6, CAS number: 2249718-27-0, Chlorantraniliprole, Chlordane, Chlorfenapyr, Chloroprallethrin, Chromafenozide, Clenpirin, Cloethocarb, Clothianidin, 2-chlorophenyl N-methylcarbamate (CPMC), Cyanofenphos, Cyantraniliprole, Cyclaniliprole, Cyclobutrifluram, Cycloprothrin, Cycloxaprid, Cycloxaprid, Cyenopyrafen, Cyetpyrafen (or Etpyrafen), Cyflumetofen, Cyfluthrin, Cyhalodiamide, Cyhalothrin, Cypermethrin, Cyphenothrin, Cyproflanilide, Cyromazine, Deltamethrin, Diafenthiuron, Dialifos, Dibrom, Dicloromezotiaz, Diflovidazine, Diflubenzuron, dimpropyridaz, Dinactin, Dinocap, Dinotefuran, Dioxabenzofos, Emamectin, Empenthrin, Epsilon-momfluorothrin, Epsilon-metofluthrin, Esfenvalerate, Ethion, Ethiprole, Etofenprox, Etoxazole, Famphur, Fenazaquin, Fenfluthrin, Fenitrothion, Fenobucarb, Fenothiocarb, Fenoxycarb, Fenpropathrin, Fenpyroxymate, Fensulfothion, Fenthion, Fentinacetate, Fenvalerate, Fipronil, Flometoquin, Flonicamid, Fluacrypyrim, Fluazaindolizine, Fluazuron, Flubendiamide, Flubenzimine, Flucitrinate, Flucycloxuron, Flucythrinate, Fluensulfone, Flufenerim, Flufenprox, Flufiprole, Fluhexafon, Flumethrin, Fluopyram, Flupyradifurone, Flupyrimin, Fluralaner, Flupentiofenox, Fluvalinate, Fluxametamide, Fosthiazate, Gamma-Cyhalothrin, Gossyplure™, Guadipyr, Halofenozide, Halofenozide, Halofenprox, Heptafluthrin, Hexythiazox, Hydramethylnon, Imicyafos, Imidacloprid, Imiprothrin, Indoxacarb, Iodomethane, Iprodione, Isocycloseram, Isothioate, Ivermectin, Kappa-bifenthrin, Kappa-tefluthrin, Lambda-Cyhalothrin, Lepimectin, Lufenuron, Metaflumizone, Metaldehyde, Metam, Methomyl, Methoxyfenozide, Metofluthrin, Metolcarb, Mexacarbate, Milbemectin, Momfluorothrin, nicofluprole Niclosamide, Nitenpyram, Nithiazine, Omethoate, Oxamyl, Oxazosulfyl, Parathion-ethyl, Permethrin, Phenothrin, Phosphocarb, Piperonylbutoxide, Pirimicarb, Pirimiphos-ethyl, Polyhedrosis virus, Prallethrin, Profenofos, Profenofos, Profluthrin, Propargite, Propetamphos, Propoxur, Prothiophos, Protrifenbute, Pyflubumide, Pymetrozine, Pyraclofos, Pyrafluprole, Pyridaben, Pyridalyl, Pyrifluquinazon, Pyrimidifen, Pyrimostrobin, Pyriprole, Pyriproxyfen, Resmethrin, Sarolaner, Selamectin, Silafluofen, Spinetoram, Spinosad, Spirodiclofen, Spiromesifen, Spirotetramat, Sulfoxaflor, Tebufenozide, Tebufenpyrad, Tebupirimiphos, Tefluthrin, Temephos, Tetrachloraniliprole, Tetradiphon, Tetramethrin, Tetramethylfluthrin, Tetranactin, Tetraniliprole, Theta-cypermethrin, Thiacloprid, Thiamethoxam, Thiocyclam, Thiodicarb, Thiofanox, Thiometon, Thiosultap, Tioxazafen, Tolfenpyrad, Toxaphene, Tralomethrin, Transfluthrin, Triazamate, Triazophos, Trichlorfon, Trichloronate, Trichlorphon, Triflumezopyrim, Tyclopyrazoflor, Zeta-Cypermethrin.

### EXAMPLES

The Examples which follow serves to illustrate the invention and in particular demonstrate the surprising effect of the use of specific amounts of the organic acid citric acid as a buffering component on spiropidion stability in a heat storage test and thus demonstrate a viable composition for commercial pest control uses. Compositions according to the present invention are prepared according to known formulation methods, eg, for a water-dispersible (wettable) granule.

Referring to Table 1 below, Composition A is a composition as a water-dispersible granule not according to the invention (without citric acid present) and Composition B is a composition as a water-dispersible granule according to the invention (with citric acid present). Composition A and Composition B are identical with the exception of the inclusion of citric acid and a slightly lower filler amount present for Composition B to compensate for the inclusion of the citric acid component.

To test the robustness of chemical stability of the active ingredients (spiropidion and acetamiprid), samples of Composition A and Composition B were slurried in 50% by weight of water and stored at 54° C. for 2 weeks.

TABLE 1

| | Composition A | Composition B |
|---|---|---|
| Component | (% by weight) | (% by weight) |
| Spiropidion | 30 | 30 |
| Acetamiprid | 24 | 24 |
| Sodium sulfate | 5 | 5 |
| Citric acid | — | 1 |
| Dispersant | 17 | 17 |
| Anti-foaming agent | 2 | 2 |
| Filler | 22 | 21 |

As can be seen at Table 2 below, after slurrying, Composition B according to the invention remains within a 5% degradation limit for spiropidion which is considered acceptable, whereas Composition A not according to the invention relates to an unacceptable degradation of spiropidion (greater than 20% loss).

TABLE 2

| | Composition A | |
|---|---|---|
| | (not according | |
| | to the inventon) | Composition B |
| % by weight remaining after | 23.9 | 28.7 |
| 2 weeks at 54° C. (Spiropidion) | | |
| % by weight remaining after | 23.8 | 23.9 |
| 2 weeks at 54° C. (Acetamiprid) | | |
| % degradation (Spiropidion) | −20.33 | −4.33 |
| % degradation (Acetamiprid) | −0.83 | −0.42 |

1. A pesticidal composition comprising:
(i) 25 to 35% by weight of spiropidion;
(ii) 20 to 30% by weight of acetamiprid; and
(iii) 2.5 to 10% by weight of a buffering agent, which based on the total weight of the composition, comprises:
(a) 2 to 7% by weight of an alkali metal sulfate and/or an alkaline earth metal sulfate, and
(b) 0.1 to 5% by weight of an organic acid.

2. The pesticidal composition according to claim 1, comprising:
(i) 28 to 32% by weight of spiropidion; and
(ii) 22 to 26% by weight of acetamiprid.

3. The pesticidal composition according to claim 1, comprising:
(iii) 4.5 to 8% by weight of a buffering agent, of which based on the total weight of the composition, comprises:
(a) 4 to 6% by weight of an alkali metal sulfate, and
(b) 0.5 to 2.5% by weight of an organic acid.

4. The pesticidal composition according to claim 1, wherein the alkali metal sulfate is potassium sulfate or sodium sulfate, and preferably sodium sulfate.

5. The pesticidal composition according to claim 1, wherein the organic acid is citric acid, or a salt thereof.

6. The pesticidal composition according to claim 1, further comprising:
(iv) 15 to 20% by weight of one or more dispersants;
(v) 1 to 5% by weight of an anti-foaming agent; and
(vi) 15 to 30% by weight of a filler, wherein optionally the filler based on the total weight of the composition comprises:
(c) 5 to 15% by weight of a polymethyl urea resin filler, and
(d) 10 to 15% by weight of a lactose monohydrate filler.

7. The composition according to claim 1, further comprising one or more additional ingredients selected from wetting agents, biocides, stabilizers and pigments.

8. The pesticidal composition according to claim 1, which is a water-disperable granule.

9. An aqueous composition comprising the pesticidal composition according to claim 1, optionally further comprising one or more adjuvants or carriers.

10. The aqueous composition according to claim 9, wherein the adjuvant is selected from a mineral oil, a vegetable oil, an esterified vegetable oil, a methylated vegetable oil or an alkyl ester phosphate-based adjuvant, and preferably, an alkyl ester phosphate-based adjuvant.

11. A method of combating and controlling pests which comprises applying to a pest, to a locus of a pest, or to a crop of a useful plant susceptible to attack by a pest, a composition according to claim 1.

12. The method according to claim 11, wherein the pest is selected from the order Homoptera, Thysanoptera, Acarina or Lepidoptera.

13. The method according to claim 12, wherein the pest is selected from white flies, aphids, thrips.

14. The method according to claim 10, wherein:
(i) the plant is selected from soybean and cotton; or
(ii) fruit and vegetables, in particular Cucurbita or Solanaceae.

15. The method according to claim 10, wherein the plant is selected from cucumber, melon, watermelon, citrus, onion, grape, tomato, pepper, chili, potato, okra.
